(19) United States
(12) Patent Application Publication
(10) Pub. No.: US 2013/0254106 A1
(43) Pub. Date: Sep. 26, 2013

(54) Gift Card and Charitable Donation Piggybank System

(71) Applicant: Virtual Piggy, Inc., Hermosa Beach, CA (US)

(72) Inventors: Jo Webber, Hermosa Beach, CA (US); Pradeep Ittycheria, Hermosa Beach, CA (US)

(73) Assignee: Virtual Piggy, Inc., Hermosa Beach, CA (US)

(21) Appl. No.: 13/901,397

(22) Filed: May 23, 2013

Related U.S. Application Data
(63) Continuation-in-part of application No. 13/247,572, filed on Sep. 28, 2011.
Application No. 13/247,572 is a continuation of application No. 12/991,059, filed on Apr. 8, 2011, now abandoned.
(60) Provisional application No. 61/272,232, filed on Sep. 3, 2009.

(51) Int. Cl. G06Q 30/06; G06Q 20/34

(52) U.S. Cl. CPC G06Q 30/0601; G06Q 20/34
USPC 705/41

(57) ABSTRACT

A method and system for purchasing a gift card and making a charitable donation using one or more computers comprising a non-transitory computer readable medium, a program, and a computer executable program code, the method comprising the steps of establishing a first account; establishing a second account; linking the first and second accounts; using either the first account or the second account to purchase a gift card from an online merchant; and distributing a charitable donation from the online merchant to a charitable organization after the gift card is purchased.

### CROSS REFERENCE TO RELATED APPLICATIONS

This application claims the priority and benefit of U.S. patent application Ser. No. 13/247,572, filed on Sep. 28, 2011, which claims priority to U.S. patent application Ser. No. 12/991,059, filed on Nov. 4, 2010, which claims priority to PCT Application No. US2010/047794, filed on Sep. 3, 2010, the entireties of all of which are incorporated herein by reference; and U.S. Provisional Patent Application No. 61/272,233, U.S. Provisional Patent Application No. 61/272,235, U.S. Provisional Patent Application No. 61/272,234, and U.S. Provisional Patent Application No. 61/272,232, all of which were filed on Sep. 3, 2009, and the entireties of all of which are incorporated herein by reference.

This application is related to U.S. patent application Ser. No. 12/991,063, identified by Attorney Docket No. 101035-5004-US, which claims the priority and benefit of U.S. Provisional Patent Application No. 61/272,235, which was filed on Sep. 3, 2009, and is incorporated herein by reference.

This application is related to U.S. patent application Ser. No. 12/991,053, identified by Attorney Docket No. 101035-5001-US, which claims the priority and benefit of U.S. Provisional Patent Application No. 61/272,233, which was filed on Sep. 3, 2009, and is incorporated herein by reference.

This application is related to U.S. patent application Ser. No. 12/991,057, identified by Attorney Docket No. 101035-5002-US; which claims the priority and benefit of U.S. Provisional Patent Application No. 61/272,234, which was filed on Sep. 3, 2009, and is incorporated herein by reference.

### FIELD OF THE INVENTION

The present invention relates an Internet payment system and method, and more particularly to an Internet payment system and method having a variety of customizable controls.

### BACKGROUND OF THE INVENTION

Using the Internet has become extremely easy, and one aspect of this ease is that children of very young ages are able to gain access to Internet websites of all kinds and make purchases at a variety of websites. Juxtaposed with this ease is the Children's Online Privacy Protection Act (COPPA), which lays out specific guidelines for how website operators and online businesses must interact with children 13 and under. In general COPPA requires parental notification and consent prior to an online operator's collecting, using or disclosing a child's personal information. Compliance with COPPA can be daunting for an online business. While some online businesses are taking steps to comply with COPPA, many of the new media companies including Facebook are choosing to avoid COPPA compliance by restricting their sites to over 13's, and foregoing a significant business opportunity in interacting with the under 13 market segment. In the past, parents were often happy to give their children small amounts of money to buy comics and candy from a corner store, there is no equivalent mechanism currently for the internet. The generation of children growing up today have never known a world where the internet was not present and they expect to be able to play games, interact with friends and make purchases online. There is ever increasing pressure on the parents and guardians to provide more online access to their children, while at the same time a worrying lack of control in the online world.

Parental controls are known and generally fall into two categories: active control and passive control. Active controls hardware and software firewalls; and hardware access controls and systems) prevent a child from accessing information over the Internet that a parent does not want them to retrieve and view. Passive controls (e.g., a software audit system) allow a parent to audit the information their children have been accessing and the activities their children have been performing while online. While these active and passive control systems help parents to control the information available to children via the Internet, there are no provisions to control the types of services that children may sign up for and/or purchase over the Internet.

Currently, parents may either provide their children with a credit card or purchase a pre-paid card so that their children may conduct a monetary transaction on the Internet. While this may work for a few instances, it is not a viable option with the rapid growth of websites, online games and online applications appealing to children and the ever increasing online footprint of children. The credit card is also particularly troubling since it provides no control or limitation on what or how much the child can acquire.

With the rapid proliferation of websites, online games, and online applications for children under 13, there is a need for a system that parents can setup and children can use to conduct online monetary transactions while limiting or obviating a child's need to provide their personal information. Thus, a system is needed that will enable a parent to manage a child's access and personal information provided to websites, or in the alternative provide parental consent to the collection and use of certain necessary information as well as to control how money is spent at the websites by a child.

### SUMMARY OF THE PREFERRED EMBODIMENTS

In accordance with an aspect of the present invention, there is provided a computer-implemented system for gift card purchases that comprises one or more computers comprising one or more non-transitory computer-readable physical storage media that includes a program, computer executable program code, and a database; a first account having one or more settings, wherein the first account is associated with one or more identifiable payment accounts, the settings of the first account being stored in the database on at least one of the one or more physical storage media, the settings of the first account comprising the identity of each of the one or more identifiable payment accounts; a second account having one or more settings, the settings of the second account being stored in the database on at least one of the one or more physical storage media. The first and second accounts are linked such that the settings of the second account are controlled by at least one of the one or more computers and made to be consistent with the settings of the first account. The system is configured such that a purchase of one or more gift cards can be made from the first account using at least one of the one or more identifiable payment accounts. The system is configured such that the one or more gift cards becomes associated with the second account for purchases from the second account using at least one of the one or more gift cards. The system is configured such that the settings of the second account are communicated to at least one of the one or more computers before a purchase is made. At least one of the one or more computers verifies that the settings of the second account are consistent with the settings of the first account before a purchase can be made.

In a preferred embodiment of the present invention, the system is further configured such that a monetary donation is distributed to a charity after the gift card is purchased. In another preferred embodiment of the present invention, the first account is established with a partner bank. In another preferred embodiment of the present invention, the one or more identifiable payment accounts comprises a debit card. In another preferred embodiment of the present invention, the one or more settings of the first and second accounts are stored in a secure database, in another preferred embodiment of the present invention, the system is farther configured such that one or more contributors is authorized to purchase one or more gift cards that become accessible to the second account following purchase. Preferably, the system is further configured such that a monetary donation is distributed to a charity after the gift card is purchased. In another preferred embodiment of the present invention, the gift card is physically sent to a user of the second account.

In accordance with another aspect of the present invention there is provided a system that comprises one or more computers comprising one or more non-transitory computer-readable physical storage media that includes a program, computer executable program code, and a database; a first account having one or more settings, wherein the first account is associated with one or more identifiable payment accounts, the settings of the first account being stored in the database on at least one of the one or more physical storage media, the settings of the first account comprising the identity of each of the one or identifiable payment accounts; a second account having one or more settings, the settings of the second account being stored in the database on at least one of the one or more physical storage media, the settings of the second account comprising the identity of at least one of the one or more identifiable payment accounts of the first account such that the at least one of the one or more identifiable payment accounts of the first account becomes associated with the second account. The first and second accounts are linked such that the settings of the second account are controlled by at least one of the one or more computers and made to be consistent with the settings of the first account. The system is configured such that a purchase of a gift card can be made from the second account using at least one of the one or more identifiable payment accounts associated with the second account. The system is configured such that the settings of the second account are communicated to at least one of the one or more computers before a purchase is made. The one or more computers verifies that the settings of the second account are consistent with the settings of the first account before a purchase can be made.

In a preferred embodiment of the present invention, the system is further configured such that a monetary donation is distributed to a charity after the gift card is purchased. In another preferred embodiment of the present invention, the first account is established with a partner bank. In another preferred embodiment of the present invention, the one or more identifiable payment accounts comprises a debit card. In another preferred embodiment of the present invention, the one or more settings of the first and second accounts are stored in a secure database. In another preferred embodiment of the present invention, the system is further configured such that one or more contributors is authorized to purchase one or more gift cards that become accessible to the second account following purchase. Preferably, the system is further configured such that a monetary donation is distributed to a charity after the gift card is purchased. In another preferred embodiment of the present invention, the gift card is physically sent to a user of the second account.

In accordance with another aspect of the present invention there is provided a method for purchasing a gift card and making a charitable donation using one or more computers comprising a non-transitory computer readable medium, a program, and a computer executable program code, the method comprising the steps of establishing a first account; establishing a second account; linking the first and second accounts; using either the first account or the second account to purchase a gift card from an online merchant; and distributing a charitable donation from the online merchant to a charitable organization after the gift card is purchased. In a preferred embodiment of the present invention, the method further comprises adding the gift card electronically to the second account to be used by the second account for online purchases. In another preferred embodiment of the present invention, the method further comprises physically sending the gift card to a user of the second account.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an example of a local area network (LAN) 100 that is connected to the Internet and in which the inventive method may be utilized;

FIG. 2 illustrates the TCP/IP Layering Model;

FIG. 3 illustrates a system according to an exemplary embodiment of the present invention;

FIG. 4 is a flow chart illustrating a method for implementing a system according to an exemplary embodiment of the present invention;

FIG. 5 is a flow chart illustrating a method for authorizing a contributor according to an exemplary embodiment of the present invention;

FIG. 6 is an exemplary screen shot of the preferences setup according to an exemplary embodiment of the present invention;

FIG. 7 is an exemplary monthly spending report according to an exemplary embodiment of the present invention;

FIG. 8 is a flow chart illustrating a method for implementing the spending functionality of system according to an exemplary embodiment of the present invention;

FIG. 9 illustrates an exemplary application of the system according to an exemplary embodiment of the present invention; and

FIG. 10 illustrates an exemplary preferences add child profile screen according to an exemplary embodiment of the present invention.

FIG. 11 is a flow chart illustrating a gift card component according to an exemplary embodiment of the present invention.

FIG. 12 is a flow chart illustrating a gift card and charitable donation component according to an exemplary embodiment of the present invention.

### DETAILED DESCRIPTION OF THE PREFERRED EMBODIMENTS

Reference will now be made in detail to the embodiments of the present invention, examples of which are illustrated in the accompanying drawings. The following description of embodiments of the present invention refers to the accompanying figures. Where appropriate, the same reference numbers in different figures refer to the same or similar elements. The following description and figures are illustrative and are not to be construed as limiting. Numerous specific details are described to provide a thorough understanding of the disclosure. However, in certain instances, well known or conventional details are not described in order to avoid obscuring the description of inventive aspects of the present invention. References to one or an embodiments in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments but not necessarily by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure may be discussed below, or elsewhere in the specification, to provide additional guidance to the practitioner regarding the description of the disclosure. For convenience, certain terms may be highlighted, for example using italics and/or quotation marks; however, the use of highlighting has no influence on the scope and meaning of a term. The scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms may be provided. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art in the field of the present invention. In the case of conflict, the present document, including definitions, will control.

In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented by any type of user (i.e., not limited to parent and child) and on any type of standalone system or client-server compatible system containing any type of client, network, server, and database elements.

Software and web or internet implementations of the present invention could be accomplished with standard programming techniques with rule based logic and other logic to accomplish the various steps of the present invention described herein. It should also be noted that the terms “component,” “module,” or “step,” as may be used herein and in the claims, are intended to encompass implementations using one or more lines of software code, macro instructions, hardware implementations, and/or equipment for receiving manual inputs, as will be well understood and appreciated by those of ordinary skill in the art.

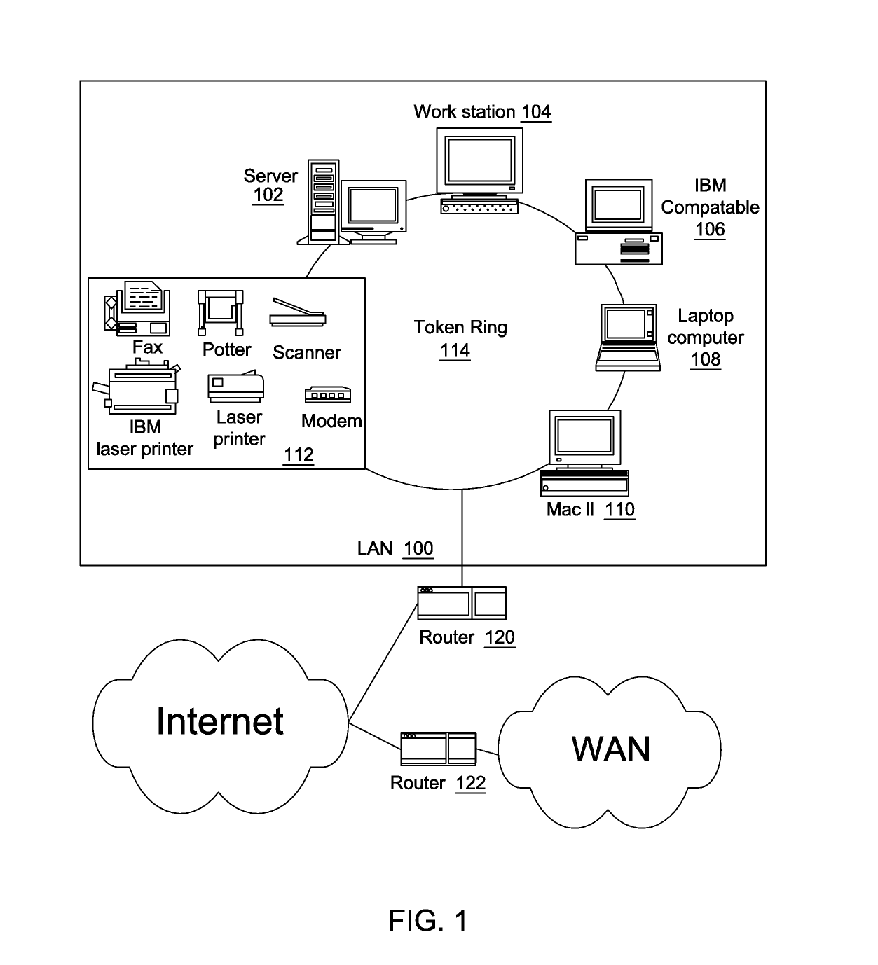

FIG. 1 illustrates an example of a local area network (LAN) 100 that is connected to the Internet and in which the inventive system and method may be utilized LAN 100 comprises a server 102, four computer systems 104, 106, 108, 110, and peripherals, such as printers and other devices 112, that may be shared by components on LAN 100. Computer systems 104, 106, 108, 110 may serve as clients for server 102 and/or as clients and/or servers for each other and/or for other components connected to LAN 100. Components on LAN 100 are preferably connected together by cable media, for example unshielded twisted pair (UTP) Category 5 copper cable, and the network topology may be an Ethernet topology 114. It should be apparent to those of ordinary skill in the art that other media, for example, fiber optic or wireless radio frequency media, may also connect LAN 100 components. It should also be apparent that other network topologies, such as Token Ring, may be used.

Data may be transferred between components on LAN 100 in packets, i.e., blocks of data that are individualy transmitted over LAN 100. Routers 120, 122 create an expanded network by connecting LAN 100 to other computer networks, such as the Internet, other LANs or Wide Area Networks (WAN). Routers are hardware devices that may include a conventional processor, memory, and separate I/O interface for each network to which it connects. Hence, components on the expanded network may share information and services with each other. In order for communications to occur between components of physically connected networks, all components on the expanded network and router 304s that connect them must adhere to a standard protocol. Computer networks connected to the Internet and to other networks typically use TCP/IP Layering Model Protocol. It should be noted that other internetworking protocols may be used.

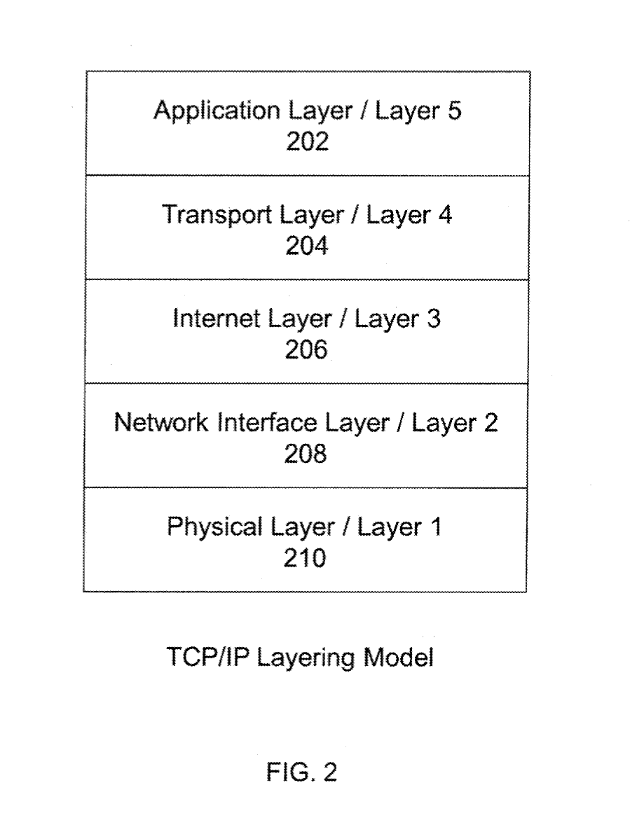

FIG. 2 illustrates the TCP/IP Layering Model, which is comprised of an application layer (Layer 5) 202, a transport layer (Layer 4) 204, an Internet layer (Layer 3) 206, a network interface layer (Layer 2) 208, and a physical layer (Layer 1) 210. Application layer protocols 202 specify how each software application connected to the network uses the network. Transport layer protocols 204 specify how to ensure reliable transfer among complex protocols. Internet layer protocols 206 specify the format of packets sent across the network as well as mechanisms used to forward packets from a computer through one or more routers to a final destination. Network interface layer protocols 208 specify how to organize data into frames and how a computer transmits frames over the network. Physical layer protocols 210 correspond to the basic network hardware. By using TCP/IP Layering model protocols, any component connected to the network can communicate with any other component connected directly or indirectly to one of the attached networks.

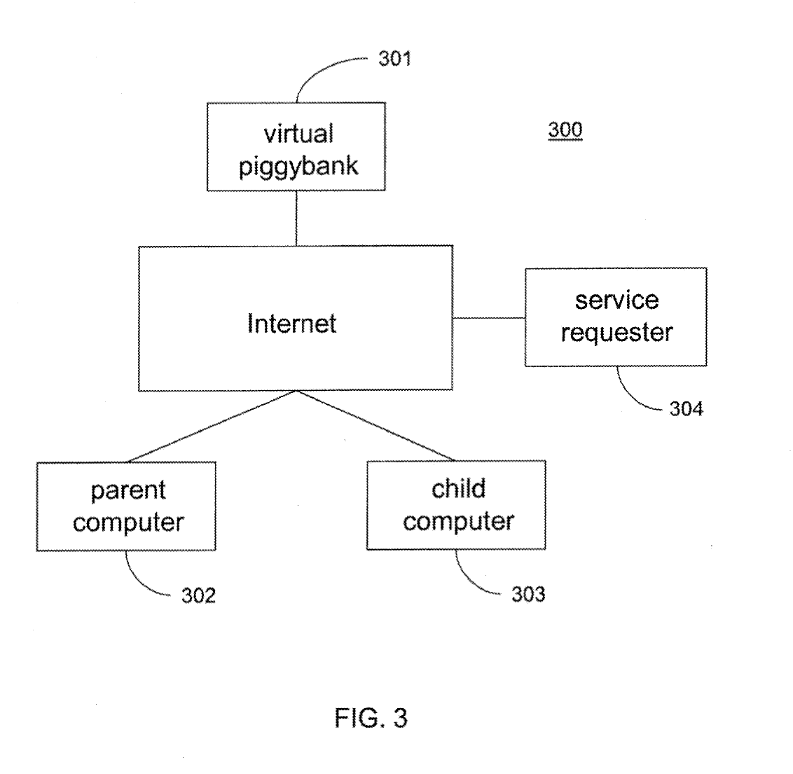

FIG. 3 illustrates a system according to an exemplary embodiment of the present invention.

As shown in FIG. 3, the system 300 includes a system server 301, parent computer 302, child computer 303, and service requester 304. The system server 301 may include a persistent software system and service that allow one or more persons responsible for one or more children to establish a controlled money management and payment system for use over the Internet. The adult preferences are stored on a database, and include parental/guardian preferences and controls for the money management. The system provides an Application Programming Interface (API) that exposes software functions that other websites, web services and Internet enabled desktop applications can use to enforce the adult preferences when children try to purchase items online. The websites, web services and Internet enabled desktop applications partner with the present system, and an account is created. Each of the parent computer 302 and child computer 303 may be a desktop computer, laptop computer, tablet or portable computer, smartphone, mobile phone, or other portable computing device. Service requester 304 may include any online application such as websites, online stores, online games, and online applications.

The following description uses as an example a parent as the person desiring to set controls regarding Internet use and a child as being the Internet user who will be controlled. These are only examples, and the invention is not limited to those two classes of people. For example, the following description would be equally applicable to an employer and employee.

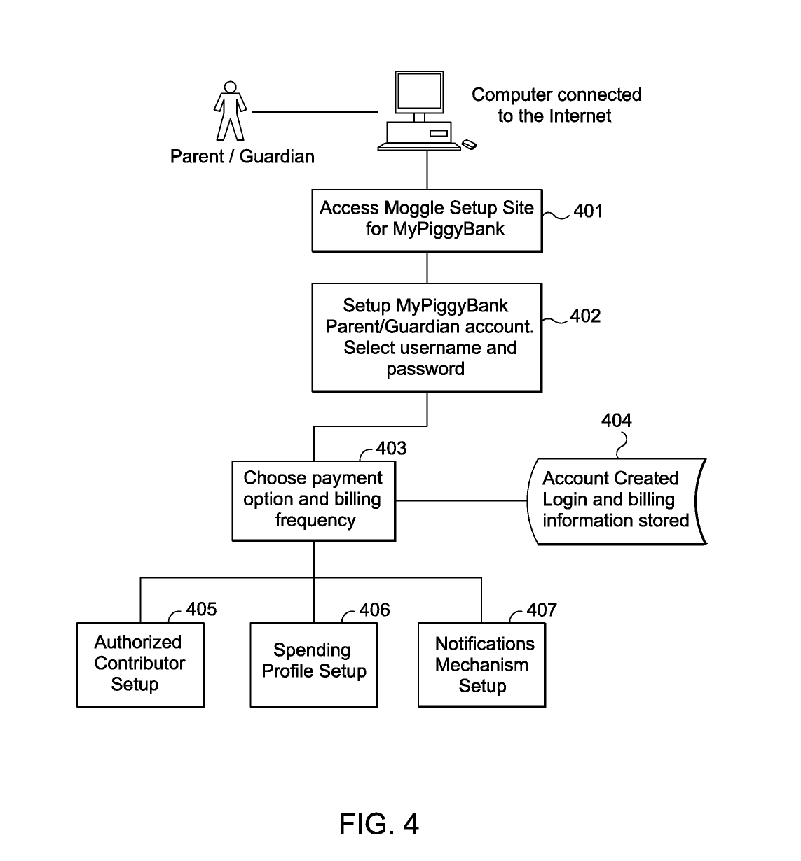

FIG. 4 is a flow chart illustrating a method for implementing a system according to a first exemplary embodiment of the present invention.

At step 401, a parent accesses the system via the Internet to establish a child account. For example, the system may include an internet bank account for use by a child, but the system is not limited to this. In order to establish a child account, a parent may first establish a parental account.

At step 402, a parent may establish parental account. The system may guide the parent through the set up of a parental account. To establish a parental account, a parent profile is created. A parent profile allows a parent to provide information that allows the system to interact with a parent. For example, the system may support OpenID. A parent may be able to use an OpenID account to establish a parent profile. However, the system may request additional information as well, such as a password, name (first, middle and last), address information, verification preference such as e-mail or short message service (SMS) that is used to verify a parental account, primary phone number, mobile phone number that may be used if SMS is selected as a verification preference so that SMS messages may be sent to a mobile phone, a primary e-mail address that may be used if e-mail selected as verification preference, secondary e-mail, password reminder questions, time-zone such that dates and times in the system are based on this time-zone and not the time-zone of the server, and currency preferences.

The parental account is secure and can only be accessed with the correct user name and password. All data transmissions may be encrypted and secure, such as all profile information. Passwords that may be used by the parent, child or others designated to properly use the system may have expiration dates to insure password strength. After a parental account is established, a parent may then establish one or more child accounts. The settings of a child account may then be controlled by the parental account. For example, the system may present a number of options from which a parent may choose such that various controls may be imposed on a child by the system.

At step 403, the system has the parent choose a payment option and/or billing frequency. For example, charges made to a child account may be applied to a credit card, debit card, other bank account, or may be billed to a parent on a periodic basis. This information also will be secured through encryption and passwords.

A parent may establish one or more payment accounts. A payment account is the account that will be used to make payment for purchases made by a child via a child account. For example, a PayPal or Google payment account may be supported by the system. Of course, the payment account may be any known to those skilled in the art. The parent may provide a User name and password associated with a payment account so that payments from a child account may be charged to the payment account. The system may verify the validity of the account using the adaptive account API for Authentication. A parent may provide the following information relating to a payment account: a) payment account name; b) payment account User name and password; c) payment account billing address (e.g., street number, street name, city, state, zip, country); and d) whether to accept outside payments to determine if someone else can fund this account. The last option will be discussed later.

At step 404 a parental account is created. In addition, one or more child accounts also may be created at this time. Account information, such as a user name, password, or payment information may be stored in a secure database by the system server.

To establish a child account, a child profile is created. A child profile may include a User name, password, and payment method, such as a payment account. A child may use the user name and password to conduct transactions on websites, online games and online applications that are approved by a parent through the system.

Also, a child may add items to a wish-list, and a parent may review and approve items on a child's wish-list. A parent may either buy or remove an item from a child's wish-list. The wish-list may be customized. For example, items in a wish-list may expire and be removed from the wish-list based on the settings of the wish-list.

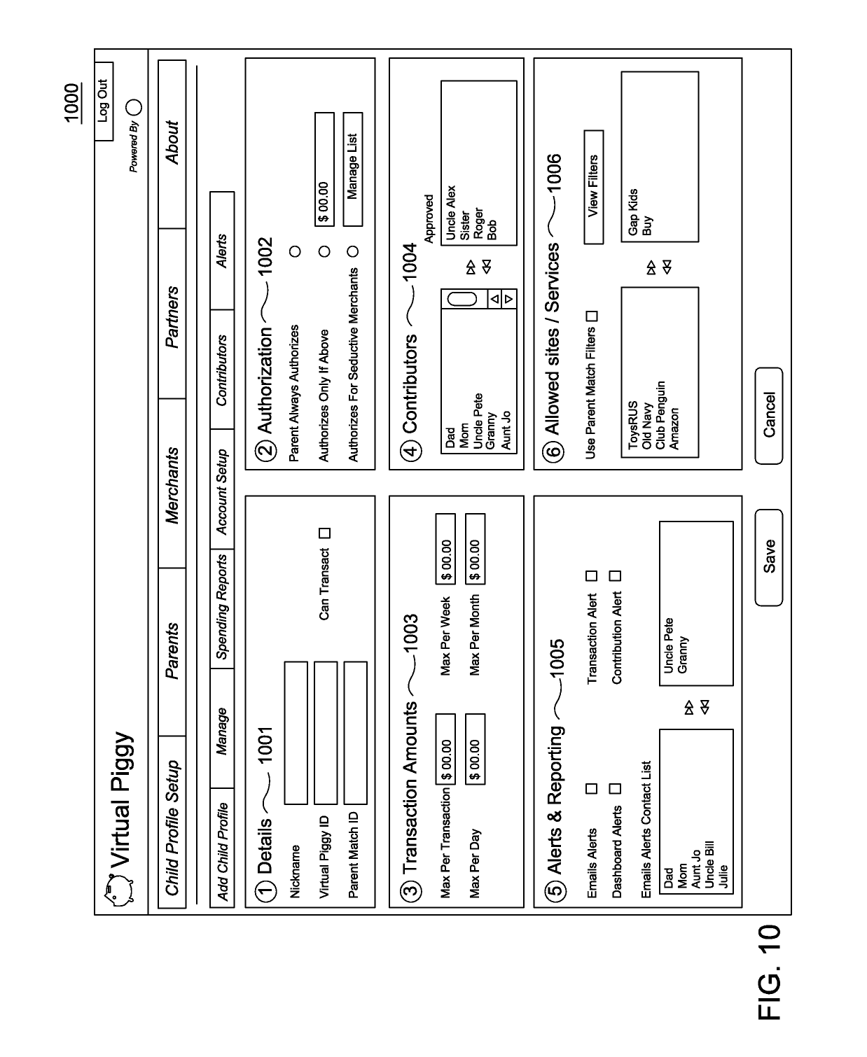

Referring to FIG. 10, illustrated is an exemplary preferences add child profile screen according to an exemplary embodiment of the present invention.

As shown in FIG. 10, the add profile screen 1000 may be divided into several exemplary screen portions 1001-1006. At screen portion, 1001 a parent may identify a child by name or nickname. Also, a child may be given a child account user name that is associated with a parent account user name.

At screen portion 1002, a parent may authorize service requesters, including websites and other Internet based applications, that a child may visit, from which a child may make purchases, etc. A parent can control whether every service requester needs to be approved by a parent. The parent can also selectively define which service requesters need to be approved while other services may be automatically approved.

At screen portion 1003, a parent may approve transactions from the child account based on a spending amount. A spending limit that limits the amount of money that a child can spend without obtaining parental approval, or a periodic spending limit that limits the amount of money a child can spend on a periodic basis such as per week, per month, or over any particular time limit. Alternatively, a parent may seta spending limit that limits the amount of money a child can spend on an occasional basis, such as a child's birthday or other holiday. In another alternative, a parent may specify a payment account balance limit such that if the linked payment account balance goes below a specified balance, no additional transactions will be permitted from a child account linked to it.

At screen portion 1004, a parent may designate contributors to a child account. For example, a contributor may be another parent, grandparent, aunt, uncle, or other adult responsible for a child. At screen portion 1005, a parent may specify that notifications be sent for any information regarding the child account. Notifications may be sent by e-mail, SMS, voicemail, or the like. In addition, a parent may specify that notifications be sent to a contributor. At screen portion 1006, a parent may authorize certain service requesters for use by a child.

Referring back to FIG. 4, at step 405, the system may allow the parent to designate one or more contributors to a child account. A contributor may be a person other than a parent who may add money into the system. For example, a grandparent, uncle, aunt, or other close family member may be designated as a contributor. The system may allow a parent to impose one or more controls on a contributor. For example, a parent may designate a money limit that a contributor may add to a child account. Such a money limit may be determined by the total amount of money that is presently available to a child in a child account. Alternatively, a money limit may be applied per contributor. In addition, a parent may limit the frequency with which a contributor may add money to a child account.

For example, a parent may designate a person as a contributor by providing that person's name and e-mail address to the system. The system may send an e-mail along with an authentication code and a link to a contributor. This link may not expire so that a contributor person can bookmark this page to send repeatedly money when he/she wants. A contributor may then go to the link in the e-mail, enter the code, the validity of which is then determined, and if the code is valid then a contributor may be presented with a form that will allow them to enter their credit card information or payment account information, such as a PayPal Google account.

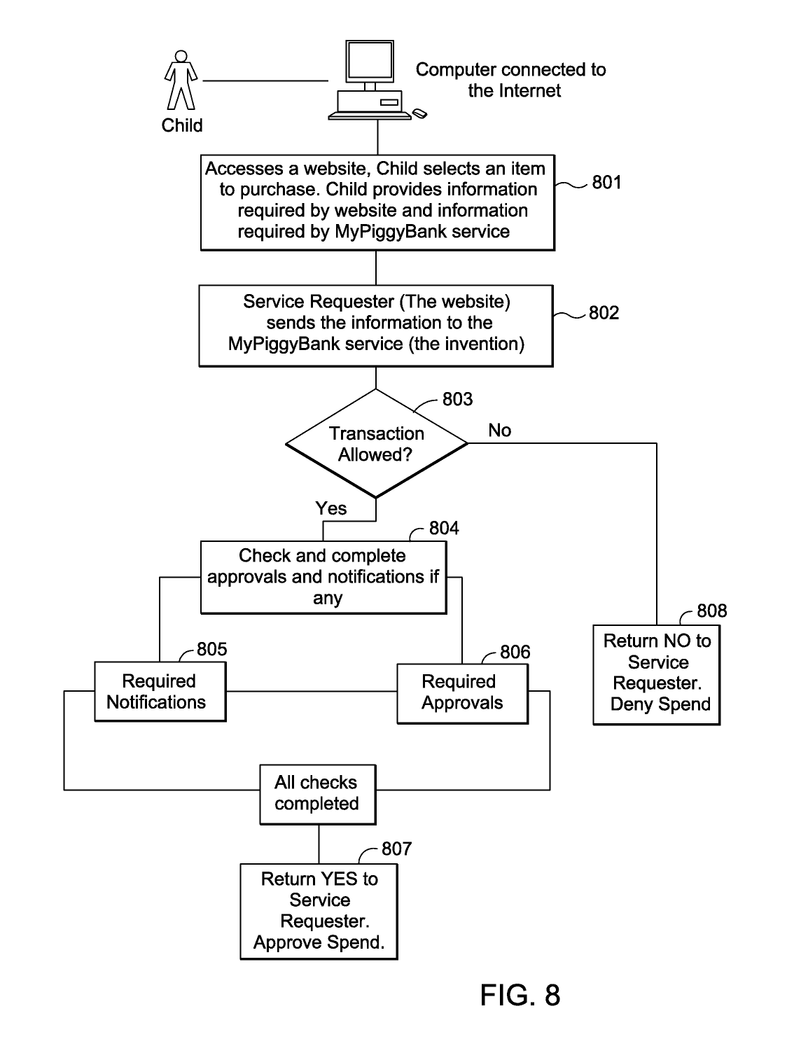

At step 406, the system may allow a parent to setup a child profile. The system may allow a parent to impose one or more controls on a child by setting up a child profile. A child profile may include a list of approved websites (i.e., Service Requester of FIGS. 3 and 8) where a child is authorized to spend money from a child account, a spending limit that limits the amount of money that a child can spend without obtaining parental approval, or a periodic spending limit that limits the amount of money a child can spend on a periodic basis such as per week, per month, or over any particular time limit. Alternatively, a parent may set a spending limit that limits the amount of money a child can spend on an occasional basis, such as a child's birthday or other holiday. In another alternative, a parent may specify a payment account balance limit such that if the linked payment account balance goes below a specified balance, no additional transactions will be permitted from a child account linked to it.

In addition, the system also may allow a parent to specify a time period during which a child may spend money from a child account. For example, a time period may be certain hours of the day, certain days of the week, or any period so desired.

At step 407, the system may allow a parent to setup specific notifications. Notifications may be sent by e-mail, SMS, voicemail, or the like. Such notifications may include any information regarding the account, such as funds, usage, etc. For example, a parent or contributor may receive notifications concerning the amount of money available to a child or recent purchases of a child, if more than a certain number of transactions are carried out at a particular merchant or by a child over the course of a day, if suspicious behavior occurs (such as a number of unsuccessful login attempts or simultaneous login attempts were made). In another example, a parent or contributor may receive a notification requesting approval of a particular transaction of the child account. In this example, a reply SMS message or e-mail may be sent by a parent or contributor to approve a transaction. Alternatively, the system may provide one or more links that may be clicked upon to approve or decline a particular transaction. If a notification is provided by phone, a request for approval may be requested after the recital of an automated message, and approval may be solicited through key selection.

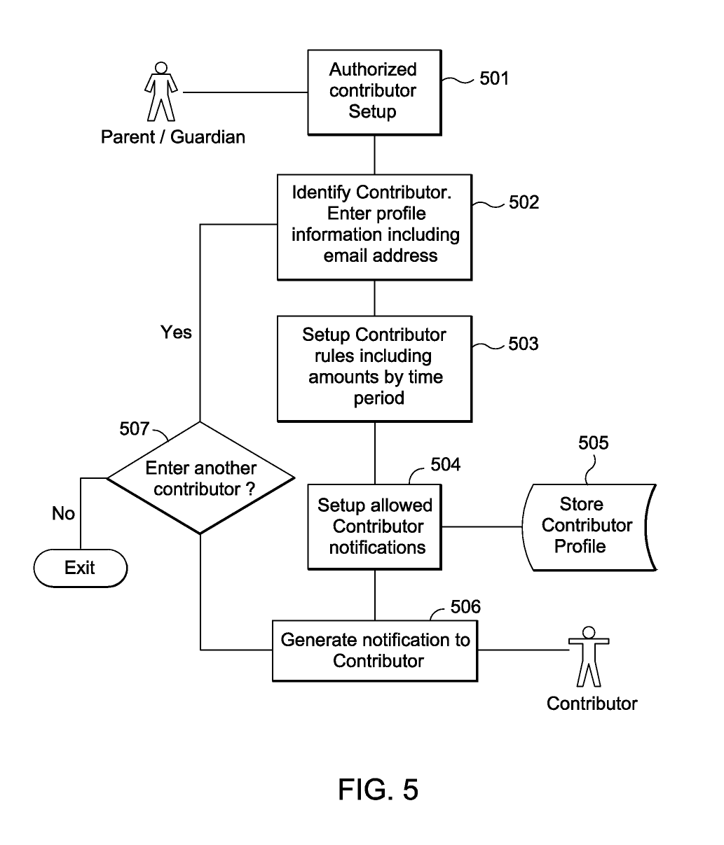

FIG. 5 is a flow chart illustrating a method for authorizing a contributor according to an exemplary embodiment of the present invention.

At step 501, a parent accesses the system and selects an option to change Authorized Contributor Setup. As discussed above, a contributor may be a person other than a parent who may add money into a child account of the system. The system may allow the parent to designate one or more contributors to a child account.

At step 502, a parent enters profile information for a contributor that will be authorized by a parent to contribute funds to a child's account in the system. The profile information may include the contributor's name, address, email address, and any other information that will uniquely identify the contributor.

At step 503, the system may allow a parent to impose one or more controls on a contributor. A parent is presented with a variety of controls that may be applied to a contributor regarding contributions that may be made to a child account. For example, a parent may designate a money limit that limits the amount of money a contributor may add to a child account. Such a money limit may be determined by the total amount of money that is presently available to a child account. Alternatively, a money limit may be applied per contributor. In addition, a parent may limit the frequency with which a contributor may add money to a child account.

At step 504, the system may allow a parent to set specific notifications to be sent to a contributor. Such notifications may include any information regarding a child account, such as funds, usage, etc.

At step 505, profile information for a contributor is stored in a secure database by the system. Account information such as a user name, password, or payment information, and notification sending information may be stored in a secure database by the system.

At step 506, a parent then selects a notification mechanism that the virtual bank sends to the contributor. For example, a notification may be sent by e-mail, SMS, or voicemail. Of course, notifications also may be sent to a parent.

At step 507, a parent is given the option of adding additional contributors. If a parent desires to add an additional contributor, a parent again enters profile information for a contributor at step 502, and again proceeds through the steps outlined above.

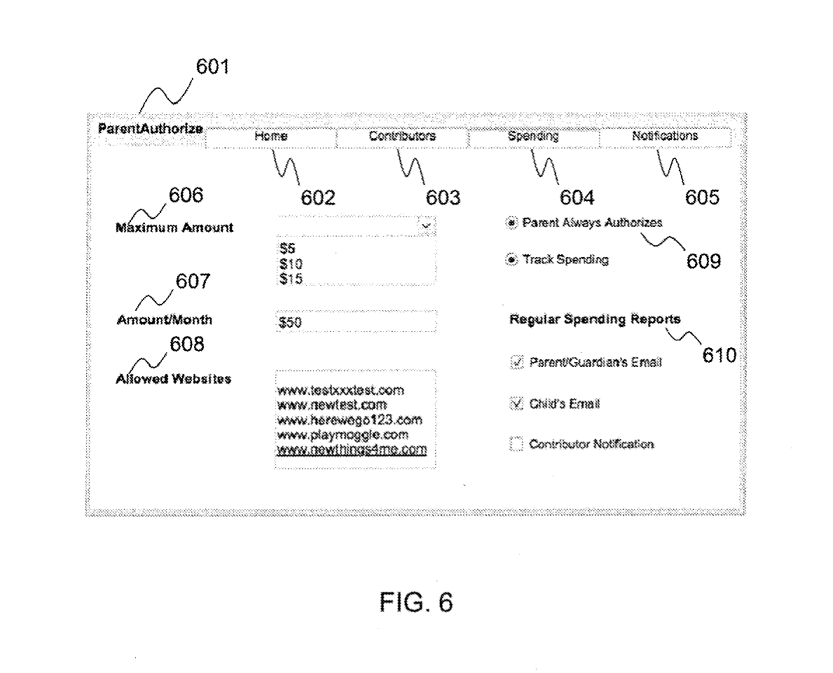

FIG. 6 is an exemplary screen shot of the preferences setup according to an exemplary embodiment of the present invention. The system may be implemented as a secure website a parent sees when setting up the preferences. Parent window 601 illustrates the main parental authorized information, which may include a Home tab 602, Contributors tab 603, Spending tab 604 and Notifications tab 605. The Home tab 602 may contain the general preferences for the parent, including basic contact information for the parent; email, fax, phone, etc. The Contributors tab 603 may hold preferences associated with the authorized contributors. The Spending tab 604 may contain information and preferences related to a child's allowed spending capabilities. This information may include, but is not limited to the maximum amount in a single transaction 606, total spending amount per month 607, websites on which the child may spend funds from the system 608, preferences around parental authorization (e.g., all purchases, purchases over a certain amount, purchases of certain types of product) 609, and preferences around who receives reports and notifications of child's actual spending 610 and frequency of reports.

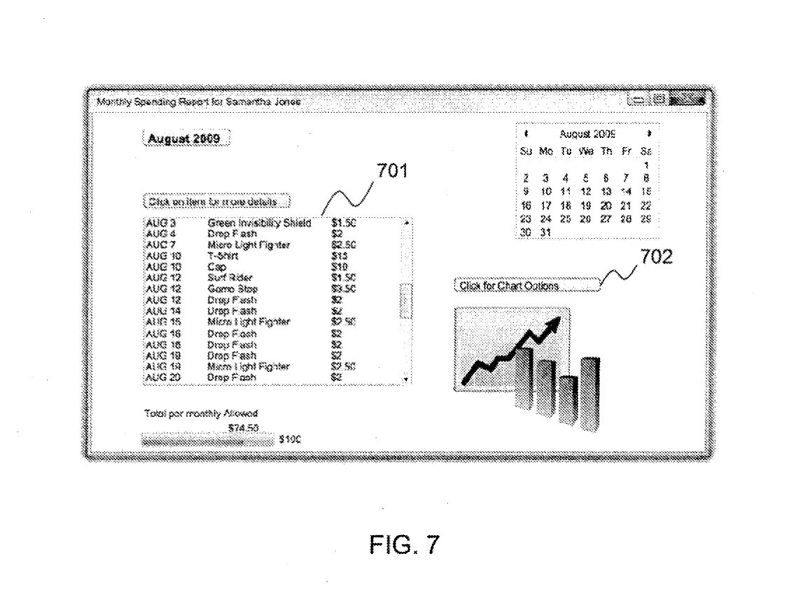

FIG. 7 is an exemplary monthly spending report according to an exemplary embodiment of the present invention. The monthly report may contain information about the child's spending patterns 701 including an itemized list of all purchased items with the ability to drill down and get further details on the item. Further details would show information, such as the website from which the item was purchased, the total amount spent on that website to date, the time of purchase, etc. A parent may be able to see a child's spending patterns compared to prior months and compared to the total monthly spend allowed. A parent may also be able to chart the child's spending data 702, and in the case of a multi-child family, the parent will be able to compare the profiles of all of their children.

A parent may view a spending report by logging into the system. A spending report may be an onscreen report that a parent can print or e-mail if desired. A spending report is customizable, and may show any combination of transaction dates, transaction amounts, service requesters, daily, weekly and monthly sub-totals. For example, a spending report may be generated for a particular service requester.

FIG. 8 is a flow chart illustrating a method for implementing the child spending functionality of the system according to an exemplary embodiment of the present invention.

At step 801, a child accesses an Internet website and selects an item for purchase. Here, the system may first determine whether a parent has allowed a child to access the website that the child is attempting to access. If a child is allowed to access the website, child may then enjoy the website's content. Otherwise, a child may be redirected to an alternate website.

At step 802, the website (i.e., Service Requester) makes a request to the system. The request package contains all the required information necessary to identify the child attempting to make a purchase to the system plus all the information about the proposed transaction.

A service requester may establish a merchant account with the system. A merchant account allows a service requester to provide information to the system to contact the service requester. For example, the system may support OpenID. A service requester may use their OpenID account to setup a merchant account. In addition, a service requester may establish a payment acceptance account. This account will be used to accept payment. For example, a service requester may use PayPal or a Google account linked with a bank account associated with the service requester. The system may verify the validity of the account using the adaptive account API for Authentication.

At step 803, the system examines the request. In particular, the request is checked against a child profile to determine whether a transaction is allowed or not. A child profile includes information necessary to determine whether a transaction is allowed. For example, a child profile may include a list of approved websites where a child is authorized to spend money from a child account, a spending limit limiting the amount of money that a child can spend without obtaining parental approval, or a periodic spending limit limiting the amount of money a child can spend per week or per month, or over any particular time limit. In addition, the system also may allow a parent to specify a time period during which a child may spend money from a child account.

The virtual bank notifies the service requester whether the transaction is approved or not at steps 807 and 808, respectively. At the same time, if the transaction is approved, the system may determine whether further approvals and/or notifications are required at step 804. If notifications are required, the required notification is sent to a parent or contributor, as appropriate, at step 805. Similarly, if a further approval is required, a seeking approval message is sent to a parent or contributor, as appropriate, at step 806. For example, an e-mail or SMS containing a seeking approval message may be sent to a parent or contributor. A parent or contributor may approve the pending transaction in a variety of ways such as reply SMS message, return e-mail, or by logging onto a parental or contributor account.

Thus, when a child logs onto the Internet and attempts to make a purchase at a Service Requester site that was previously designated as controlled by the system, the Service Requester bank makes a web service call to the system. The system exposes the preferences that were established by an adult, as described above, to the Service Requester. The preferences may be exposed to the service requester via an application programming interface through a web service, which may be a software system designed to support interoperable machine-to-machine interaction over the Internet.

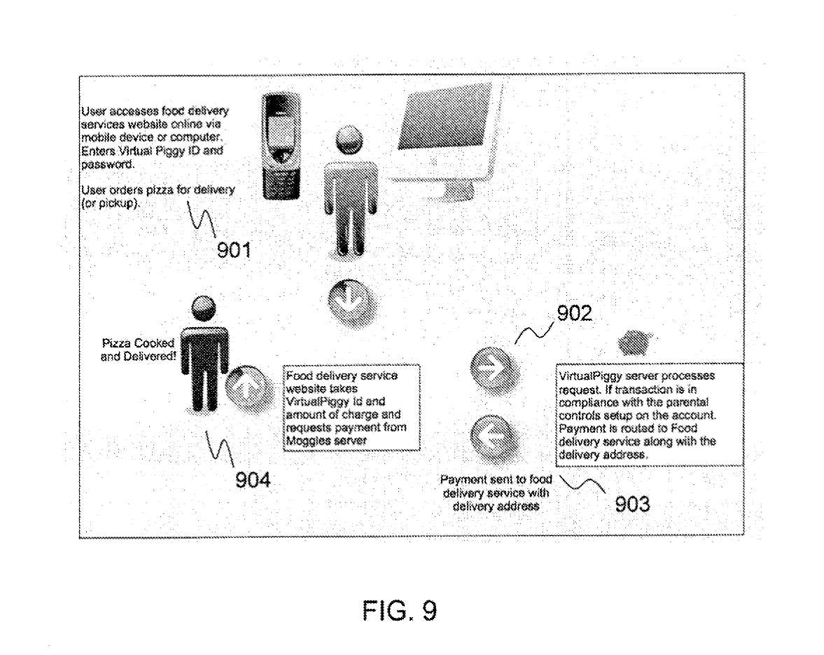

FIG. 9 illustrates an exemplary application of the system according to an exemplary embodiment of the present invention.

As shown in FIG. 9, a child user of a child account may access a service requester, such as a restaurant or food delivery system, at step 901. In this example, the service requester may obtain child account identifying information and present the child account information to the system at step 902. Once the method for implementing the child spending functionality of the system, as shown in FIG. 8, is performed and the service requester approved, a purchase from the service requester may be made. The system then ensures that the service requester is paid for the selected service or item, at step 903. Accordingly, the service requester may then provide the purchased service or item, as shown in step 904.

As discussed above, a service requester may establish a merchant account with the system. A merchant account allows a service requester to provide information to the system to contact the service requester. For example, the system may support OpenID. A service requester may use their OpenID account to setup a merchant account. In addition, a service requester may establish a payment acceptance account. This account will be used to accept payment. For example, a service requester may use PayPal or a Google account linked with a bank account associated with the service requester. The system may verify the validity of the account using the adaptive account API for Authentication.

The system may generate revenues by charging service requesters a fee per transaction. For example, the system may use a payment account, such as a PayPal or Google account, as a payment network. The payment account may charge its standard rate (on average 2.9%+0.30 USD per transaction) in additional to the system rate.

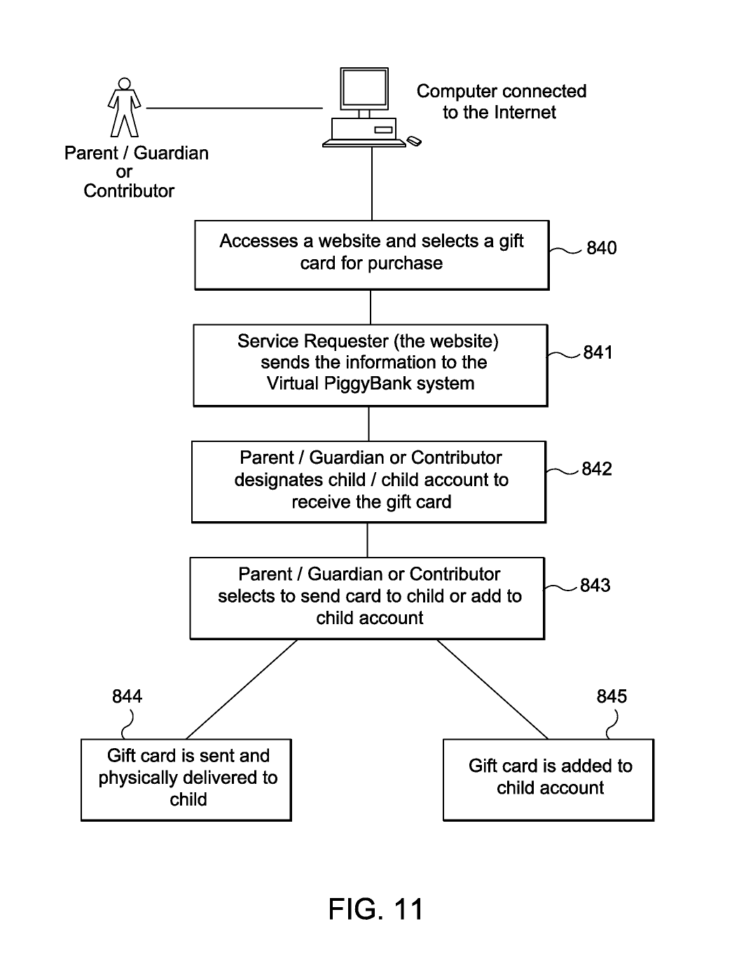

Referring now to FIG. 11, another preferred embodiment of the system is shown. In this preferred embodiment, a parent account user (depicted in FIG. 4) or an authorized contributor account user (depicted in FIG. 5), can use their account to add one or more gift cards to a child account. At step or component 840 of FIG. 1 a parent or authorized contributor accesses a website and selects a gift card for purchase. At step or component 841, the parent or authorized contributor uses their system login credentials (created at FIGS. 4 and/or 5), to initiate purchase of the selected gift card, and the parent or authorized contributor is directed to the system.

Still referring to FIG. 11, at step or component 842, the system presents the parent or authorized contributor with all child accounts associated with the parent account, and the parent designates the child account (and corresponding child) that is to receive the gift card. At step or component 843, the parent or authorized contributor selects whether the gift card is to be physically delivered to the child (such as, for example, by mail or other courier delivery mode), or added in electronic form to the child account. As shown at step or component 844, if the parent or authorized contributor selects the former (i.e., physical delivery), then the selected gift card is physically delivered to the child, and the child at that point may use the gift card for purchases at physical store locations or online. Alternatively, as shown at step or component 845, if the parent or authorized contributor selects the latter (i.e., that the gift card be added to child account), then the selected gift card is added in electronic form to the child account for use by the child in purchases the child may make through the system. In the scenario illustrated at step or component 845, online purchases the child may make using the gift card through the system are subject to the same parental controls and settings that ordinarily would be in place for any other type of purchase through the system.

In another preferred embodiment, the gift card amount that is added to the child account is reflected in a total child account balance, and, as online purchases are made using the gift card, the total child account balance is reduced correspondingly. In another preferred embodiment, the child account provides and lists a gift card inventory, and the child account user is able to link to store websites and redeem any gift cards directly from within the child account, such as, for example, by using web links within or proximate the gift card inventory list. In another preferred embodiment, the child receives a communication (such as an email communication), informing the child of the gift card amount and that the gift card has been purchased on his or her behalf by the parent or other authorized contributor, and that the gift card is being physically delivered or added to the child account, as the case ma be. In another preferred embodiment, a child may electronically forward to another person (e.g., a child friend), one or more of the gift cards that have been added to his or her child account.

Referring now to FIG. 8, in another preferred embodiment of the present invention, at step or component 801 of FIG. 8, it is contemplated and intended to be within the scope of the present invention that one or more gift cards may be one of, or among the items a child selects to purchase through the steps and components of the system of FIG. 8. In another preferred embodiment, the controls and settings of the parent account may be modified to block or restrict the child account from being able to purchase gift cards from one or more merchants of the parent account user's choosing.

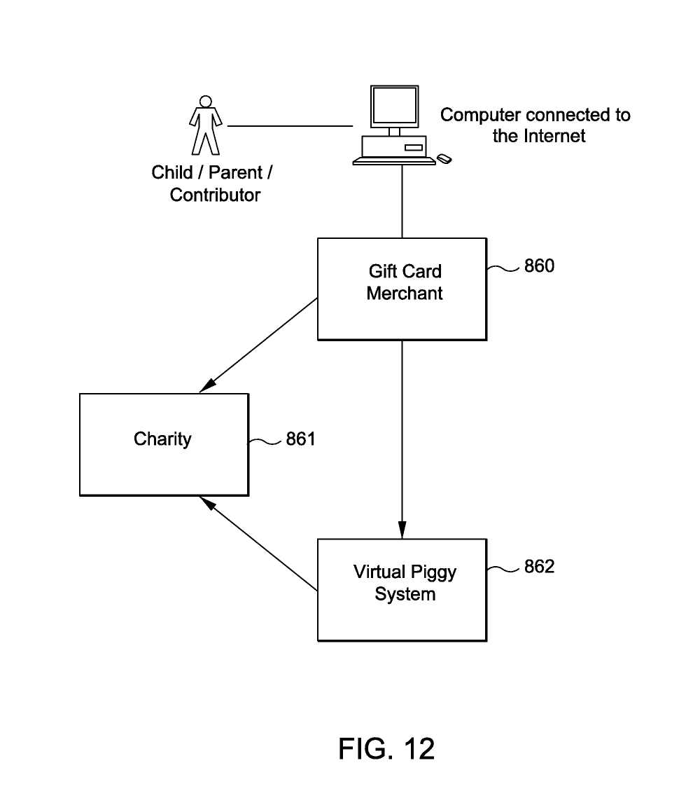

Referring now to FIG. 12, in another preferred embodiment of the present invention, when a child selects and purchases a gift card from a gift card merchant using the system (at steps or components 801 through 804 of FIG. 8), it is contemplated and intended to be within the scope of the present invention that a fixed dollar amount may be donated to a charity or charitable organization, as shown at step or component 861 of FIG. 12. Through links or relationships that are established between charities on the one hand, and gift card merchants on the other, a certain fixed dollar amount gets paid to a charity upon gift card purchase by a child using a child account (at steps or components 801 through 804 of FIG. 8), or by a parent or authorized contributor at steps or components 840 through 845 of FIG. 11). For example (and not by way of limitation), a child account user, a parent account user, or an authorized contributor account user may purchase a $50 gift card from a gift card merchant online, and a set dollar amount (e.g. $2) is distributed online to a certain charity or charitable organization (by virtue of the links/relationships that are established), while the entire $50 gift card amount with that merchant is either sent to the child (step or component 844 of FIG. 11), or added to the child account electronically (step or component 845 of FIG. 11).

Still referring to FIG. 12, the settlement of payment from the gift card merchant to the charity or charitable organization can be accomplished either directly from the gift card merchant to the charity (i.e., from step or component 860 directly to step or component 861, as shown in FIG. 12), or settlement can be accomplished through the system as an intermediary (i.e., from step or component 860, through the system at step or component 862, to the charity or charitable organization at step or component 861). In another preferred embodiment of the present in invention, the identity of the parent or authorized contributor that purchased the gift card (and made the corresponding donation to the charity), as well as the identity of the charity or charitable organization, is visible or communicated to the child account or child account user.

It will be apparent to those skilled in the art that various modifications and variations can be made in the system and method for the system of the present invention without departing from the spirit or scope of the invention. Thus, it is intended that the present invention cover the modifications and variations of this invention provided they come within the scope of the appended claims and their equivalents.

The particular arrangement shown in the figures and described herein is intended to be only exemplary. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Where the context permits, words in the above Detailed Description of the Preferred Embodiments using the singular or plural number may also include the plural or singular number respectively. The word “or” in reference to a list of two or more items, covers all of the following interpretations of the word; any of the items in the list, all of the items in the list, and my combination of the items in the list.

The above detailed description of embodiments of the disclosure is not intended to be exhaustive or to limit the teachings to the precise form disclosed above. While specific embodiments of, and examples for the disclosure are described above for illustrative purposes, various equivalent modifications are possible within the scope of the disclosure, as those skilled in the relevant art will recognize. Further any specific numbers noted herein are only examples; alternative implementations may employ differing values or ranges.

Any patents and applications and other references that may be noted her in, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure. Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A computer-implemented system for gift card purchases, the system comprising:
one or more computers comprising one or more non-transitory computer-readable physical storage media that includes a program, computer executable program code, and a database;
a first account having one or more settings, wherein the first account is associated with one or more identifiable payment accounts, the settings of the first account being stored in the database on at least one of the one or more physical storage media, the settings of the first account comprising the identity of each of the one or more identifiable payment accounts;
a second account having one or more settings, the settings of the second account being stored in the database on at least one of the one or more physical storage media;
wherein the first and second accounts are linked such that the settings of the second account are controlled by at least one of the one or more computers and made to be consistent with the settings of the first account;
wherein the system is configured such that a purchase of one or more gift cards can be made from the first account using at least one of the one or more identifiable payment accounts;
wherein the system is configured such that the one or more gift cards becomes associated with the second account for purchases from the second account using at least one of the one or more gift cards;
wherein the system is configured such that the settings of the second account are communicated to at least one of the one or more computers before a purchase is made; and
wherein at least one of the one or more computers verifies that the settings of the second account are consistent with the settings of the first account before a purchase can be made.

2. The computer-implemented system according to claim 1, wherein the system is further configured such that a monetary donation is distributed to a charity after the gift card is purchased.

3. The computer-implemented system according to claim 1, wherein the first account is established with a partner bank.

4. The computer-implemented system according to claim 1, wherein the one or more identifiable payment accounts comprises a debit card.

5. The computer-implemented system according to claim 1, wherein the one or more settings of the first and second accounts are stored in a secure database.

6. The computer-implemented system according to claim 1, wherein the system is further configured such that one or more contributors is authorized to purchase one or more gift cards that become accessible to the second account following purchase.

7. The computer-implemented system according to claim 6, wherein the system is further configured such that a monetary donation is distributed to a charity after the gift card is purchased.

8. The computer-implemented system according to claim 1, wherein the gift card is physically sent to a user of the second account.

9. A computer-implemented system for gift card purchases, the system comprising:
one or more computers comprising one or more non-transitory computer-readable physical storage media that includes a program, computer executable program code, and a database;
a first account having one or more settings, wherein the first account is associated with one or more identifiable payment accounts, the settings of the first account being stored in the database on at least one of the one or more physical storage media, the settings of the first account comprising the identity of each of the one or more identifiable payment accounts;
a second account having one or more settings, the settings of the second account being stored in the database on at least one of the one or more physical storage media, the settings of the second account comprising the identity of at least one of the one or more identifiable payment accounts of the first account such that the at least one of the one or more identifiable payment accounts of the first account becomes associated with the second account;
wherein the first and second accounts are linked such that the settings of the second account are controlled by at least one of the one or more computers and made to be consistent with the settings of the first account;
wherein the system is configured such that a purchase of a gift card can be made from the second account using at least one of the one or more identifiable payment accounts associated with the second account;
wherein the system is configured such that the settings of the second account are communicated to at least one of the one or more computers before a purchase is made; and
wherein at least one of the one or more computers verifies that the settings of the second account are consistent with the settings of the first account before a purchase can be made.

10. The computer-implemented system according to claim 9, wherein the system is further configured such that a monetary donation is distributed to a charity after the gift card is purchased.

11. The computer-implemented system according to claim 9, wherein the first account is established with a partner bank.

12. The computer-implemented system according to claim 9, wherein the one or more identifiable payment accounts comprises a debit card.

13. The computer-implemented system according to claim 9, wherein the one or more settings of the first and second accounts are stored in a secure database.

14. The computer-implemented system according to claim 9, wherein the system is further configured such that one or more contributors is authorized to purchase one or more gift cards that become accessible to the second account following purchase.

15. The computer-implemented system according to claim 14, wherein the system is further configured such that a monetary donation is distributed to a charity after the gift card is purchased.

16. The computer-implemented system according to claim 9, wherein the gift card is physically sent to a user of the second account.

17. A method for purchasing a gift card and making a charitable donation using one or more computers comprising a non-transitory computer readable medium, a program, and a computer executable program code, the method comprising the steps of:
establishing a first account;
establishing a second account;
linking the first and second accounts;
using either the first account or the second account to purchase a gift card from an online merchant; and
distributing a charitable donation from the online merchant to a charitable organization after the gift card is purchased.

18. The method of claim 17 further comprising adding the gift card electronically to the second account to be used by the second account for online purchases.

19. The method of claim 17 further comprising physically sending the gift card to a user of the second account.
